(19) United States
(12) Patent Application Publication
(10) Pub. No.: US 2014/0292900 A1
(43) Pub. Date: Oct. 2, 2014

(54) Water-Based Ink for Ink-Jet Recording, Ink Cartridge and Ink-Jet Recording Apparatus

(71) Applicants: Tatsunosuke Hoshi, Nagoya-shi (JP); Kenjiro Imai, Toyohashi-shi (JP)

(72) Inventors: Tatsunosuke Hoshi, Nagoya-shi (JP); Kenjiro Imai, Toyohashi-shi (JP)

(73) Assignee: BROTHER KOGYO KABUSHIKI KAISHA, Nagoya-shi (JP)

(21) Appl. No.: 14/227,044

(22) Filed: Mar. 27, 2014

(30) Foreign Application Priority Data
Mar. 29, 2013 (JP) 2013-073973

(51) Int. Cl. C09D 11/00; B41J 2/01

(52) U.S. Cl. CPC C09D 11/36; B41J 2/01
USPC 347/20; 106/31.86; 347/86

(57) ABSTRACT

A water-based ink for ink-jet recording includes: a pigment; water; tripropylene glycol contained not more than 28% by weight in the water-based ink; and 1,2-diol having a number of 8 to 10 carbon atoms; wherein a weight ratio (X:Y) of the tripropylene glycol (X) to the 1,2-diol (Y) in the water-based ink is in a range of X:Y=50:1 to 2.4:1.

### CROSS REFERENCE TO RELATED APPLICATION

The present application claims priority from Japanese Patent Application No. 2013-073973 filed on March 29, 2013, the disclosure of which is incorporated herein by reference in its entirety.

### BACKGROUND OF THE INVENTION

1. Field of the Invention:

The present invention relates to a water-based ink for ink-jet recording, an ink cartridge and an ink-jet recording apparatus.

2. Description of the Related Art:

Conventionally, glycol ether has been used for suppressing any density non-uniformity (unevenness in chromatic gradating) characteristic to a water-based ink for ink-jet recording which uses a pigment (hereinafter referred to as a “water-based pigment ink” in some cases; see, for example, Japanese Patent Application Laid-open Nos. 2012-167227 and 2012-213950).

In the recent years, there is a demand for increasing the recording speed, and as a method for realizing this, performing recording operation in a low resolution is being considered. It has been difficult, however, to sufficiently suppress the density non-uniformity in a water-based pigment ink when performing the recording operation in a low resolution, simply by using the glycol ether.

In view of the above situation, an object of the present teaching is to provide a water-based ink for ink jetrecording using a pigment and capable of suppressing any lowering in print quality due to the density non-uniformity.

### SUMMARY OF THE INVENTION

According to a first aspect of the present teaching, there is provided a water-based ink for ink-jet recording including:

a pigment;

water;

tripropylene glycol contained not more than 28% by weight in the water-based ink; and

1,2-diol having a number of carbon atoms of 8 to 10;

wherein a weight ratio (X:Y) of the tripropylene glycol (X) to the 1,2-diol (Y) in the water-based ink is in a range of X:Y=50:1 to 2.4:1.

According to a second aspect of the present teaching, there is provided an ink cartridge including the water-based ink for ink-jet recording of the first aspect.

According to a third aspect of the present teaching, there is provided an ink jet recording apparatus including: the water-based ink for ink-jet recording of the first aspect; an ink accommodating section configured to accommodate the water-based ink; and an ink discharge mechanism configured to discharge the ink accommodated in the ink accommodating section.

### BRIEF DESCRIPTION OF THE DRAWINGS

FIG. 1 is a schematic perspective view showing an example of the configuration of an ink-jet recording apparatus of the present teaching.

### DESCRIPTION OF THE PREFERRED EMBODIMENTS

The inventors of the present teaching found out, through various investigations and studies, that the lowering in print quality due to the density non-uniformity can be suppressed by adding tripropylene glycol (hereinafter referred to as “TPG”) to a water-based pigment ink. However, any attempt to suppress the lowering in print quality only with TPG resulted in lowering the discharge stability of the water-based pigment ink due to the addition of a necessary amount of TPG. In view of this, using 1,2-diol having a number of carbon atoms of 8 to 10 together with TPG at the above-described specific ratio made it possible to obtain a water-based pigment ink satisfying all the solubility, the suppression of the lowering in print quality and the discharge stability. Note that as shown in Examples and Comparative Examples which will be described later on, the suppression of the lowering in print quality is an unique effect obtained in a case that TPG and the 1,2-diol having the number of 8 to 10 carbon atoms are used together; any combined use of dipropylene glycol (hereinafter referred to as “DPG”) or triethylene glycol (hereinafter referred to as “TEG”), which is similar to TPG, with the 1,2-diol having the number of 8 to 10 carbon atoms and any combined used of TPG with the 1,2-butanediol which is similar to the 1,2-diol having the number of 8 to 10 carbon atoms cannot suppress the lowering in print quality.

An explanation will be given about a water-based ink for ink-jet recording (hereinafter referred to as a “water-based ink” or an “ink” in some cases) of the present teaching. The water-based ink of the present teaching contains a pigment and water.

In the present teaching, the pigment is not particularly limited and includes, for example, carbon black, an inorganic pigment, an organic pigment, etc. The carbon black includes, for example, furnace black, lamp black, acetylene black, channel black, etc. The inorganic pigment includes, for example, titanium oxide, inorganic pigments based on iron oxide, inorganic pigments based on carbon black, etc. The organic pigment includes, for example, azo-pigments such as azo lake, insoluble azo-pigment, condensed azo-pigment, chelate azo-pigment, etc.; polycyclic pigments such as phthalocyanine pigment, perylene and perynon pigments, anthraquinone pigment, quinacridone pigment, dioxadine pigment, thioindigo pigment, isoindolinone pigment, quinophthalone pigment etc.; dye lake pigments such as basic dye type lake pigment, acid dye type lake pigment etc.; nitro pigments; nitroso pigments; aniline black daylight fluorescent pigment; and the like. Any other pigment is also usable provided that the pigment is dispersible in a water phase (aqueous phase). Specific example of the pigments as described above include, for example, C. I. Pigment Blacks 1, 6, and 7; C. I. Pigment Yellows 1, 2, 3, 12, 13, 14, 15, 16, 17, 55, 73, 74, 75, 83, 93, 94, 95, 97, 98, 114, 128, 129, 138, 150, 151, 154, 180, 185, and 194; C. I. Pigment Oranges 31 and 43; C. I. Pigment Reds 2, 3, 5, 6, 7, 12, 15, 16, 48, 48:1, 53:1, 57, 57:1, 112, 122, 123, 139, 144, 146, 149, 166, 168, 175, 176, 177, 178, 184, 185, 190, 202, 221, 222, 224, and 238; C. I. Pigment Violet 196; C. I. Pigment Blues 1, 2, 3, 15, 15:1, 15:2, 15:3, 15:4, 16, 22, and 60; C. I. Pigment Greens 7 and 36; and the like. The water-based ink of the present teaching may be prepared by dispersing the pigment in water with a dispersant. As the dispersant, it is allowable to use, for example, any general polymeric dispersant, etc. Alternatively, in the water-based ink of the present teaching, the pigment may be subjected to polymer capsulation.

The pigment may be a self-dispersible pigment. The self-dispersible pigment is dispersible in water without using any dispersant, for example, owing to the fact that at least one of the hydrophilic functional group and the salt thereof including, for example, carbonyl group, hydroxyl group, carboxylic acid group, sulfonic acid group (sulfonate group), phosphoric acid group (phosphate group), etc. is introduced into the surfaces of the pigment particles by the chemical bond directly or with any group intervening therebetween. It is possible to use self-dispersible pigments subjected to the surface treatment by any one of methods described, for example, in Japanese Patent Application Laid-open No. 8-3498 (corresponding to U.S. Pat. No. 5,609,671) and Published Japanese Translation of PCT International Publication for Patent Application No. 2000-513396 (corresponding to U.S. Pat. No. 5,837,045), Published Japanese Translation of PCT International Publication for Patent Application No. 2008-524400 (corresponding to United States Patent Application Publication No. US 2006/0201380), Published Japanese Translation of PCT International Publication for Patent Application No. 2009-515007 (corresponding to United States Patent Application Publications No. US 2007/0100023 and No. US 2007/0100024), etc. It is possible to use, as a material for the self-dispersible pigment, either one of the inorganic pigment and the organic pigment. Further, a pigment which is suitable for the above-described treatment includes, for example, carbon black such as “MA8” and “MA100” produced by Mitsubishi Chemical Corporation, etc. As the self-dispersible pigment, it is possible, for example, to use a commercially available product. The commercially available product includes, for example, “CAB-O-JET (trade name) 200”, “CAB-O-JET (trade name) 250C”, “CAB-O-JET (trade name) 260M”, “CAB-O-JET (trade name) 270Y”, “CAB-O-JET (trade name) 300”, “CAB-0-JET (trade name) 400”, “CAB-O-JET (trade name) 450C”, “CAB-O-JET (trade name) 465M” and “CAB-O-JET (trade name) 470Y” produced by Cabot Specialty Chemicals; “BONJET (trade name) BLACK CW-2” and “BONJET (trade name) BLACK CW-3” produced by Orient Chemical Industries, Ltd.; “LIOJET (trade name) WD BLACK 002C” produced by Toyo Ink Mfg. Co., Ltd.; and the like.

With respect to the water-based ink, the density non-uniformity tends to be more problematic in a chromatic color ink than in an achromatic color ink. Accordingly, the present teaching is particularly effective for a water-based ink using a chromatic color pigment as the pigment. The term “chromatic color pigment” means a pigment that is different from pigments of white, black and gray colors that are achromatic colors, and is exemplified, for example, by yellow, magenta and cyan pigments. One type (kind) of these pigments may be used singly, or two or more types (kinds) of these pigments may be used in a mixed manner.

The solid content blending amount of the pigment (pigment solid content) with respect to the entire amount of the water-based ink is not particularly limited, and may be appropriately determined based on, for example, desired optical density or color (hue, tint), etc. The pigment solid content is, for example, in a range of 0.1% by weight to 20% by weight, is preferably in a range of 1% by weight to 15% by weight, and is more preferably in a range of 2% by weight to 10% by weight.

The water-based ink may also include a colorant that is different from the pigment, in addition to the above-described pigment. The colorant other than the pigment includes, for example, a dye, etc. Further, it is allowable that the water-based ink does not contain any other colorant that is different from the pigment. The density non-uniformity tends to occur in a case that a pigment is used as the colorant. Accordingly, the present teaching is particularly effective for a water-based ink containing substantially only the pigment, as the colorant, for example, such a water-based ink wherein the pigment is contained in the colorant in an amount within a range of 90% by weight to 100% by weight.

It is preferable that the water is ion exchange water or pure water (purified water). The blending amount of water (water ratio) with respect to the entire amount of the water-based ink is, for example, in a range of 10% by weight to 90% by weight, and preferably in a range of 40% by weight to 80% by weight. The water ratio may be, for example, the balance of the other components.

As described above, the water-based ink further contains TPG and the 1,2-diol having the number of 8 to 10 carbon atoms. It is presumed that TPG and the 1,2-diol having the number of 8 to 10 carbon atoms in the water-based ink both function to improve the wettability of the water-based ink with respect to a recording medium, thereby suppressing the density non-uniformity. For example, in a case that the recording medium is paper (paper sheet), the ink containing TPG and the 1,2-diol having the number of 8 to 10 carbon atoms has affinity to paper and colors or dyes satisfactorily the fibers of the paper, thereby reducing any density non-uniformity. The blending amount of TPG (TPG ratio) with respect to the entire amount of the water-based ink exceeds 0% by weight and is not more than 28% by weight. By making the blending amount of TPG be not more than 28% by weight, it is possible to prevent the discharge stability of the water-based pigment ink from lowering. Further, the weight ratio (X:Y) of TPG (X) to the 1,2-diol (Y) in the water-based ink is in a range of X:Y=50:1 to 2.4:1. If the weight ratio (X:Y) of TPG (X) to the 1,2-diol (Y) in the water-based ink falls outside of the range of X:Y=50:1 to 2.4:1 and thus the TPG ratio is smaller than in this range, there is a fear that the 1,2-diol might undergo separation in the water-based ink. As described above, by making the blending amount of TPG be not more than 28% by weight and by using TPG together with the 1,2-diol at the above-described specific ratio, it is possible to obtain a water-based ink satisfying all of the solubility, the suppression of lowering in print quality and the discharge stability.

Although the lowest limit of the value of the TPG ratio is not specifically limited provided that the TPG ratio satisfies the above weight ratio (X:Y), the TPG ratio is, for example, 10% by weight. It is preferable that the TPG ratio is in a range of 12% by weight to 20% by weight. By making the TPG ratio fall within the range of 12% by weight to 20% by weight, it is possible to obtain a water-based ink particularly excellent in the solubility, the suppression of lowering in print quality and the discharge stability.

Although the 1,2-diol may be straight-chain or branched chain alkanediol, the 1,2-diol is preferably the straight-chain alkanediol, and is particularly preferable at least one of 1,2-octanediol and 1,2-decanediol. By making the 1,2-diol to be the straight-chain alkanediol and making the 1,2-diol be particularly at least one of 1,2-octanediol and 1,2-decanediol, it is possible to further increase the effect of suppressing the lowering in print quality. In a case that the 1,2-diol is 1,2-decanediol, the weight ratio (X:Y) is preferably in a range of X:Y=50:1 to 5:1.

Although the blending amount of the 1,2-diol with respect to the entire amount of the water-based ink is not particularly limited, provided that the blending amount satisfies the above-described weight ratio (X:Y), the blending amount is, for example, in a range of 0.3% by weight to 5% by weight, and is preferably in a range of 0.4% by weight to 5% by weight.

It is allowable that the water-based ink further contains a water-soluble organic solvent that is different from TPG and the 1,2-diol. The water-soluble organic solvent is exemplified, for example, by a humectant which prevents the water-based ink from being dried at an end portion (forward end portion) of a nozzle of an ink jethead and a penetrant which adjusts the drying velocity on a recording medium.

The humectant is not particularly limited, and includes, for example, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyhydric alcohols such as alkylene glycol, glycerol and trimethylolpropane; 2-pyrrolidone; N-methyl-2-pyrrolidone; and 1,3-dimethyl-2-imidazolidinone. The polyalkylene glycol includes, for example, polyethylene glycol, polypropylene glycol, etc. The alkylene glycol includes, for example, diethylene glycol, triethylene glycol, dipropylene glycol, thiodiglycol, hexylene glycol, etc. One type (kind) of the humectant as described above may be used singly, or two or more types (kinds) of the humectants as described above may be used in combination. Among them, it is preferable to use polyhydric alcohol such as alkylene glycol, glycerol, etc.

The blending amount of the humectant with respect to the entire amount of the water-based ink is, for example, in a range of 0% by weight to 95% by weight, is preferably in a range of 5% by weight to 80% by weight, and is more preferably in a range of 5% by weight to 50% by weight.

The penetrant is not limited, and includes, for example, glycol ether. In a case that a large amount of the glycol ether is used in a water-based pigment ink, a compound derived from a rubber member, etc. in an ink jetrecording apparatus elutes into the water-based pigment ink in some cases and there is also a problem of evaporation of the glycol ether. Accordingly, the blending amount of the glycol ether is preferably in a range which does not cause these problems. The glycol ether is not limited, and includes, for example, ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether, etc. One type of the penetrant may be used singly, or two or more of the penetrants may be used in combination.

The blending amount of the penetrant with respect to the entire amount of the water-based ink is preferably in a range of 0% by weight to 2% by weight.

The water-based ink may further contain a conventionally known additive, as necessary. The additive includes, for example, surfactants, pH-adjusting agents, viscosity-adjusting agents, surface tension-adjusting agents, fungicides, etc. The viscosity-adjusting agents include, for example, polyvinyl alcohol, cellulose, water-soluble resin, etc.

The water-based ink can be prepared, for example, such that the pigment, water, TPG and 1,2-diol having the number of 8 to 10 carbon atoms, and optionally other additive component(s) are mixed uniformly or homogeneously by any conventionally known method, and undissolved matters are removed by a filter or the like.

As explained above, according to the present teaching, the blending amount of the tripropylene glycol in the water-based pigment ink is made be not more than 28% by weight, and the tripropylene glycol and the 1,2-diol having the number of 8 to 10 carbon atoms are used at the above-described specific ratio in the water-based pigment ink, thereby making it possible to suppress the lowering in the print quality due to the density non-uniformity.

Next, an explanation will be given about an ink cartridge of the present teaching. The ink cartridge of the present teaching is characterized by being an ink cartridge containing a water-based ink for ink jetrecording; wherein the water-based ink is the water-based ink for ink jetrecording of the present teaching. For example, any conventionally known main body (body) of an ink cartridge can be used for the main body of the ink cartridge of the present teaching.

Next, explanation will be given about an ink-jet recording apparatus and an ink-jet recording method of the present teaching.

The ink jetrecording apparatus of the present teaching is an ink-jet recording apparatus characterized by including: an ink accommodating section which accommodates an ink therein; and an ink discharge mechanism which discharges the ink accommodated in the ink accommodating section; wherein the ink accommodated in the ink accommodating section is the water-based ink of the present teaching.

The ink jetrecording method of the present teaching is an ink jetrecording method characterized by including: performing recording on a recording medium by discharging, to the recording medium, a water-based ink by an ink-jet system; and using the water-based ink for ink jetrecording of the present teaching, as the water-based ink.

The ink jetrecording method of the present teaching can be practiced, for example, by using the ink-jet recording apparatus of the present teaching. The recording includes printing a letter (text), printing an image, printing, etc.

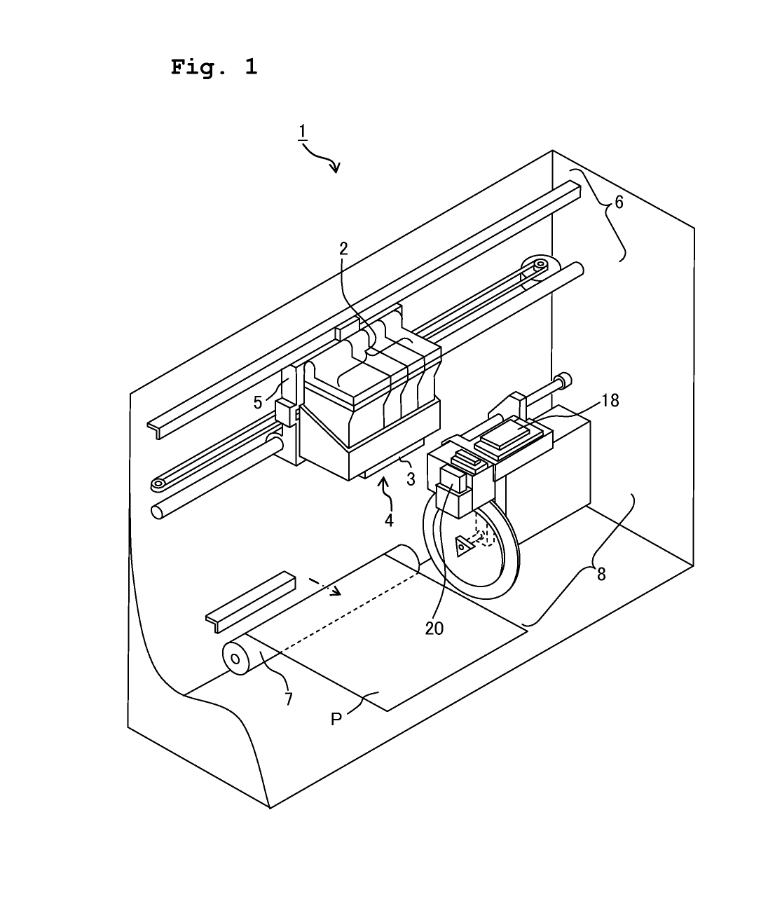

FIG. 1 shows the configuration of an example of the ink jetrecording apparatus of the present teaching. As shown in FIG. 1, an ink-jet recording apparatus 1 of the present teaching includes four ink cartridges 2, an ink discharge mechanism (ink-jet head) 3, a head unit 4, a carriage 5, a driving unit 6, a platen roller 7 and a purge device 8 as main constitutive components or parts.

The four ink cartridges 2 contain four colors of water-based inks, respectively, the four colors being yellow, magenta, cyan and black. For example, each of the water-based yellow ink, water-based magenta ink and water-based cyan ink is the water-based ink for ink jetrecording of the present teaching. It is allowable to use a general water-based black ink as the water-based black ink. The ink-jet head 3 disposed on the head unit 4 performs recording on a recording medium (for example, recording paper or recording sheet) P. The four ink cartridges 2 and the head unit 4 are provided or arranged on the carriage 5. The driving unit 6 reciprocates the carriage 5 in a linear direction. As the driving unit 6, it is possible to use, for example, a conventionally known driving unit (see, for example, Japanese Patent Application laid-open No. 2008-246821 corresponding to United States Patent Application Publication No. US2008/0241398). The platen roller 7 extends in the reciprocating direction of the carriage 5 and is arranged to face or be opposite to the ink-jet head 3.

The purge device 8 sucks or draws unsatisfactory ink (poor ink) which contains air bubbles, etc. accumulated or trapped in the inside of the ink-jet head 3. As the purge device 8, it is possible to use, for example, a conventionally known purge device (for example, see Japanese Patent Application laid-open No. 2008-246821 corresponding to United States Patent Application Publication No. US2008/0241398).

A wiper member 20 is provided on the purge device 8, at a position on the side of the platen roller 7 such that the wiper member 20 is adjacent to the purge device 8. The wiper member 20 is formed to have a spatula shape, and wipes a nozzle-formed surface of the ink-jet head 3 accompanying with the movement (reciprocating movement) of the carriage 5. In FIG. 1, a cap 18 is provided to cover a plurality of nozzles of the ink-jet head 3 which is returned to a reset position upon completion of the recording, so as to prevent the water-based inks from drying.

In the ink-jet recording apparatus 1 of the present embodiment, the four ink cartridges 2 are provided, together with the head unit 4, on one carriage 5. However, the present teaching is not limited to this. In the ink-jet recording apparatus, the respective four cartridges 2 may be provided on a carriage which is different (separate) from the carriage on which the head unit 4 is provided. Alternatively, the respective four cartridges 2 may be arranged and fixed inside the ink-jet recording apparatus, rather than being provided on the carriage 5. In such aspects, for example, each of the four cartridges 2 and the head unit 4 which is provided on the carriage 5 are connected with a tube, etc., and the water-based inks are supplied from the four cartridges 2, respectively, to the head unit 4 via the tubes.

Ink jet recording using the ink-jet recording apparatus 1 is performed, for example, in the following manner. Namely, at first, a recording paper P is supplied or fed, for example, from a paper feeding cassette or sheet feeding cassette (not shown) arranged at a side of or at a position below the ink-jet recording apparatus 1. The recording paper P is introduced or guided between the ink-jet head 3 and the platen roller 7. Then, a predetermined recording is performed on the fed or introduced recording paper P with the water-based ink(s) discharged or jetted from the ink-jet head 3. The water-based ink of the present teaching is capable of realizing stable ink discharge from the ink-jet head 3. The recording paper P after the recording is discharged from the ink-jet recording apparatus 1. According to the water-based ink of the present teaching, it is possible to obtain a recorded matter in which the lowering in print quality is suppressed. In FIG. 1, the paper feeding mechanism and paper discharge mechanism for the recording paper P are omitted in the drawing.

In the apparatus shown in FIG. 1, an ink-jet head of serial type (serial type ink-jet head) is adopted. However, the present teaching is not limited to this. The ink-jet recording apparatus may be an apparatus adopting an ink-jet head of line type (line type ink-jet head).

### EXAMPLES

Next, examples of the present teaching will be explained together with comparative examples. Note that the present teaching is not limited and is not restricted to the examples and the comparative examples which will be described below.

### Examples 1 to 21 and Comparative Examples 1 to 19

Components, except for a self-dispersible pigment, which were included in Ink Composition (TABLE 1 or TABLE 2) as indicated below were mixed uniformly or homogeneously; and thus an ink solvent was obtained. Subsequently, the ink solvent was added to the self-dispersible pigment dispersed in water, followed by being mixed uniformly. After that, the obtained mixture was filtrated through a cellulose acetate membrane filter (pore size 3.00 μm) produced by Toyo Roshi Kaisha, Ltd., and thus a water-based ink for ink jetrecording of each of Examples 1 to 21 and Comparative Examples 1 to 19 was obtained.

With respect to the water-based inks of Examples 1 to 21 and Comparative Examples 1 to 19, (a) ink observation evaluation, (b) print quality evaluation, (c) discharge stability evaluation and (d) overall evaluation were performed by the following methods.

### (a) Ink Observation Evaluation

After preparing the inks of Examples 1 to 21 and Comparative Examples 1 to 19, the respective inks were visually observed whether or not there was any separation in each of the inks, and evaluations were made for the ink observation based on the following evaluation criterion.

### <Evaluation Criterion for Evaluation of Ink Observation>

A: There was no ink separation.

C: There was an ink separation.

### (b) Print Quality Evaluation

A digital multifunction machine DCP-J525N provided with an ink jetprinter produced by Brother Industries, Ltd. was used to record an image with the water-based inks of Examples 1-21 and Comparative Examples 1-19 on recording plain paper sheets (product name: MY PAPER, produced by Ricoh Company, Ltd.), at a resolution of 600 dpi×300 dpi, and evaluation samples were prepared. Solid printing portions of the evaluation samples were visually observed, and evaluations were made for presence or absence of any density non-uniformity in the image, based on the following evaluation criterion.

### <Evaluation Criterion for Evaluation of Print Quality>

A: Any density non-uniformity was not present.

B: Slight density non-uniformity was present, but at a level causing no problems in practical use.

C: Density non-uniformity was present.

### (c) Evaluation of Discharge Stability

When exchanging an ink cartridge in the digital multifunction machine DCP-J525N provided with the ink-jet printer, purge (suction of ink by a pump) was performed in an environment in which the temperature was 40 degrees Celsius and the relative humidity was 20%; and then the digital multifunction machine DCP-J525N provided with the ink jetprinter was maintained for 7 seconds in an uncapped state in this environment. After that, ten vertical ruled lines of 1 dot were recorded on the plain paper by discharging each of the water-based inks of Examples 1-21 and Comparative Examples 1-19. The discharge stability, which was obtained when the water-based ink was maintained in the ink-jet head in the uncapped state, was evaluated in accordance with the following evaluation criterion by making comparison with vertical ruled lines (Reference) formed by the continuous recording performed without maintaining the digital multifunction machine DCP-J525N provided with the ink-jet printer in the uncapped state.

### <Evaluation Criterion for Evaluation of Discharge Stability>

A: Any dot recording delay and undischarge were not caused in 1st to 5th vertical ruled lines, and situation was equivalent to that of Reference.

B: Any dot recording delay and undischarge were not caused in the 6th to 10th vertical ruled lines, and situation was equivalent to that of Reference.

C: Dot recording delay and undischarge was caused in the 10th vertical ruled line, and situation was worse than that of Reference.

### (d) Overall Evaluation

In relation to each of the water-based inks of Examples 1-21 and Comparative Examples 1-19, the overall evaluation was performed in accordance with the following evaluation criterion on the basis of the results of (a) to (c) described above.

### <Evaluation Criterion for Overall Evaluation>

G: A or B was present in all of the evaluations (a) to (c).

NG: C was present in any one of results of (a) to (c).

The ink compositions of the water-based inks and the evaluation results of Examples 1 to 21 are shown in Table 1. Further, the ink compositions of the water-based inks and the evaluation results of Comparative Examples 1 to 19 are shown in Table 2.

TABLE 1

| | | EXAMPLES | | | | | | | | | | |
|---|---|---|---|---|---|---|---|---|---|---|---|---|
| | | EX. 1 | EX. 2 | EX. 3 | EX. 4 | EX. 5 | EX. 6 | EX. 7 | EX. 8 | EX. 9 | EX. 10 | EX. 11 |
| Ink | CAB-O-JET | 4.0 | 4.0 | 4.0 | 4.0 | 4.0 | 4.0 | 4.0 | 4.0 | 4.0 | 4.0 | — |
| Composition | (trade name) 450C (*1) | | | | | | | | | | | |
| (% by | CAB-O-JET | — | — | — | — | — | — | — | — | — | — | 5.0 |
| weight) | (trade name) 465M (*2) | | | | | | | | | | | |
| | CAB-O-JET | — | — | — | — | — | — | — | — | — | — | — |
| | (trade name) 470Y (*3) | | | | | | | | | | | |
| | Glycerol | 15.0 | 15.0 | 11.0 | — | 21.0 | 15.5 | 18.0 | 11.0 | 15.0 | 9.0 | 14.0 |
| | TPG (X) | 15.0 | 12.0 | 20.0 | 28.0 | 10.0 | 15.0 | 12.0 | 20.0 | 15.0 | 15.0 | 15.0 |
| | TEG | — | — | — | — | — | — | — | — | — | 5.0 | — |
| | 1,2-octanediol (Y) | 2.0 | 5.0 | 0.4 | 1.5 | 2.5 | — | — | — | 2.0 | 2.0 | 2.0 |
| | 1,2-decanediol (Y) | — | — | — | — | — | 1.5 | 2.4 | 0.4 | — | — | — |
| | SUNNOL | 0.2 | 0.2 | 0.2 | 0.2 | 0.2 | 0.2 | 0.2 | 0.2 | — | 0.2 | 0.2 |
| | (trade name) NL1430 (*4) | | | | | | | | | | | |
| | OLFINE | — | — | — | — | — | — | — | — | 0.2 | — | — |
| | (trade name) E1010 (*5) | | | | | | | | | | | |
| | Water | balance | balance | balance | balance | balance | balance | balance | balance | balance | balance | balance |
| X:Y (Weight Ratio) | | 7.5:1 | 2.4:1 | 50:1 | 18.7:1 | 4:1 | 10:1 | 5:1 | 50:1 | 7.5:1 | 7.5:1 | 7.5:1 |
| Evaluation | Ink Observation | A | A | A | A | A | A | A | A | A | A | A |
| | Print Quality | A | A | A | A | B | A | A | A | A | A | A |
| | Discharge Stability | A | A | A | B | A | A | A | A | A | A | A |
| | Overall Evaluation | G | G | G | G | G | G | G | G | G | G | G |

| | | EXAMPLES | | | | | | | | | |
|---|---|---|---|---|---|---|---|---|---|---|---|
| | | EX. 12 | EX. 13 | EX. 14 | EX. 15 | EX. 16 | EX. 17 | EX. 18 | EX. 19 | EX. 20 | EX. 21 |
| Ink | CAB-O-JET | — | — | — | — | — | — | — | — | — | — |
| Composition | (trade name) 450C (*1) | | | | | | | | | | |
| (% by | CAB-O-JET | 5.0 | 5.0 | 5.0 | 5.0 | 5.0 | 5.0 | 5.0 | 5.0 | 5.0 | — |
| weight) | (trade name) 465M (*2) | | | | | | | | | | |
| | CAB-O-JET | — | — | — | — | — | — | — | — | — | 4.0 |
| | (trade name) 470Y (*3) | | | | | | | | | | |
| | Glycerol | 14.0 | 10.0 | — | 20.0 | 14.5 | 17.0 | 10.0 | 14.0 | 8.0 | 15.0 |
| | TPG (X) | 12.0 | 20.0 | 28.0 | 10.0 | 15.0 | 12.0 | 20.0 | 15.0 | 15.0 | 15.0 |
| | TEG | — | — | — | — | — | — | — | — | 5.0 | — |
| | 1,2-octanediol (Y) | 5.0 | 0.4 | 1.5 | 2.5 | — | — | — | 2.0 | 2.0 | 2.0 |
| | 1,2-decanediol (Y) | — | — | — | — | 1.5 | 2.4 | 0.4 | — | — | — |
| | SUNNOL | 0.2 | 0.2 | 0.2 | 0.2 | 0.2 | 0.2 | 0.2 | — | 0.2 | 0.2 |
| | (trade name) NL1430 (*4) | | | | | | | | | | |
| | OLFINE | — | — | — | — | — | — | — | 0.2 | — | — |
| | (trade name) E1010 (*5) | | | | | | | | | | |
| | Water | balance | balance | balance | balance | balance | balance | balance | balance | balance | balance |
| X:Y (Weight Ratio) | | 2.4:1 | 50:1 | 18.7:1 | 4:1 | 10:1 | 5:1 | 50:1 | 7.5:1 | 7.5:1 | 7.5:1 |
| Evaluation | Ink Observation | A | A | A | A | A | A | A | A | A | A |
| | Print Quality | A | A | A | B | A | A | A | A | A | A |
| | Discharge Stability | A | A | B | A | A | A | A | A | A | A |
| | Overall Evaluation | G | G | G | G | G | G | G | G | G | G |

<Note that in TABLE 1>
(*1): Self-dispersible cyan pigment, produced by Cabot Specialty Chemicals, numerals in the table indicate pigment solid content amounts.
(*2): Self-dispersible magenta pigment, produced by Cabot Specialty Chemicals, numerals in the table indicate pigment solid content amounts.
(*3): Self-dispersible yellow pigment, produced by Cabot Specialty Chemicals, numerals in the table indicate pigment solid content amounts.
(*4): Sodium polyoxyethylene (3 E.O.) alkyl (C = 12, 13) ether sulfate, produced by Lion Corporation, active ingredient amount = 28% by weight, numerals in the table indicate active ingredient amounts.
(*5): Ethylene oxide (10 mole) adduct of acetylene diol, produced by Nissin Chemical Industry Co., Ltd.

TABLE 2

| | | COMPARATIVE EXAMPLES | | | | | | | | | |
|---|---|---|---|---|---|---|---|---|---|---|---|
| | | COM. | COM. | COM. | COM. | COM. | COM. | COM. | COM. | COM. | COM. |
| | | EX. 1 | EX. 2 | EX. 3 | EX. 4 | EX. 5 | EX. 6 | EX. 7 | EX. 8 | EX. 9 | EX. 10 |
| Ink | CAB-O-JET | 4.0 | 4.0 | 4.0 | 4.0 | 4.0 | 4.0 | 4.0 | 4.0 | 4.0 | 4.0 |
| Composition | (trade name) 450C (*1) | | | | | | | | | | |
| (% by | CAB-O-JET | — | — | — | — | — | — | — | — | — | — |
| weight) | (trade name) 465M (*2) | | | | | | | | | | |
| | CAB-O-JET | — | — | — | — | — | — | — | — | — | — |
| | (trade name) 470Y (*3) | | | | | | | | | | |
| | Glycerol | 17.0 | — | 27.0 | 15.0 | 15.0 | 15.5 | 15.5 | — | 15.0 | 15.0 |
| | TPG (X) | 15.0 | 32.0 | 5.0 | — | — | — | — | 32.0 | 15.0 | 15.0 |
| | DPG | — | — | — | 15.0 | — | — | — | — | — | — |
| | Polypropylene glycol | — | — | — | — | 15.0 | — | — | — | — | — |
| | TEG | — | — | — | — | — | 15.0 | — | — | — | — |
| | Polyethylene glycol 200 | — | — | — | — | — | — | 15.0 | — | — | — |
| | 1,2-octanediol (Y) | — | 2.0 | 2.5 | 2.0 | 2.0 | — | — | — | — | — |
| | 1,2-decanediol (Y) | — | — | — | — | — | 1.5 | 1.5 | 1.5 | — | — |
| | 1,2-tetradicanediol | — | — | — | — | — | — | — | — | 2.0 | — |
| | 1,2-buthanediol | — | — | — | — | — | — | — | — | — | 2.0 |
| | SUNNOL | 0.2 | 0.2 | 0.2 | 0.2 | 0.2 | 0.2 | 0.2 | 0.2 | 0.2 | 0.2 |
| | (trade name) NL1430 (*4) | | | | | | | | | | |
| | Water | balance | balance | balance | balance | balance | balance | balance | balance | balance | balance |
| X:Y (Weight Ratio) | | — | 16:1 | 2:1 | — | — | — | — | 21.3:1 | — | — |
| Evaluation | Ink Observation | A | A | C | A | C | A | A | A | C | A |
| | Print Quality | C | A | — | C | — | C | C | A | — | C |
| | Discharge Stability | A | C | — | A | — | A | A | C | — | A |
| | Overall Evaluation | NG | NG | NG | NG | NG | NG | NG | NG | NG | NG |

| | | COMPARATIVE EXAMPLES | | | | | | | | |
|---|---|---|---|---|---|---|---|---|---|---|
| | | COM. | COM. | COM. | COM. | COM. | COM. | COM. | COM. | COM. |
| | | EX. 11 | EX. 12 | EX. 13 | EX. 14 | EX. 15 | EX. 16 | EX. 17 | EX. 18 | EX. 19 |
| Ink | CAB-O-JET | — | — | — | — | — | — | — | — | — |
| Composition | (trade name) 450C (*1) | | | | | | | | | |
| (% by | CAB-O-JET | 5.0 | 5.0 | 5.0 | 5.0 | 5.0 | 5.0 | 5.0 | — | — |
| weight) | (trade name) 465M (*2) | | | | | | | | | |
| | CAB-O-JET | — | — | — | — | — | — | — | 4.0 | 4.0 |
| | (trade name) 470Y (*3) | | | | | | | | | |
| | Glycerol | 16.0 | — | 26.0 | — | 14.5 | 14.0 | 14.0 | 17.0 | — |
| | TPG (X) | 15.0 | 32.0 | 5.0 | 32.0 | — | 15.0 | 15.0 | 15.0 | 32.0 |
| | DPG | — | — | — | — | — | — | — | — | — |
| | Polypropylene glycol | — | — | — | — | — | — | — | — | — |
| | TEG | — | — | — | — | 15.0 | — | — | — | — |
| | Polyethylene glycol 200 | — | — | — | — | — | — | — | — | — |
| | 1,2-octanediol (Y) | — | 2.0 | 2.5 | — | — | — | — | — | 2.0 |
| | 1,2-decanediol (Y) | — | — | — | 1.5 | 1.5 | — | — | — | — |
| | 1,2-tetradicanediol | — | — | — | — | — | 2.0 | — | — | — |
| | 1,2-buthanediol | — | — | — | — | — | — | 2.0 | — | — |
| | SUNNOL | 0.2 | 0.2 | 0.2 | 0.2 | 0.2 | 0.2 | 0.2 | 0.2 | 0.2 |
| | (trade name) NL1430 (*4) | | | | | | | | | |
| | Water | balance | balance | balance | balance | balance | balance | balance | balance | balance |
| X:Y (Weight Ratio) | | — | 16:1 | 2:1 | 21.3:1 | — | — | — | — | 16:1 |
| Evaluation | Ink Observation | A | A | C | A | A | C | A | A | A |
| | Print Quality | C | A | — | A | C | — | C | C | A |
| | Discharge Stability | A | C | — | C | A | — | A | A | C |
| | Overall Evaluation | NG | NG | NG | NG | NG | NG | NG | NG | NG |

<Note that in TABLE 2>
(*1): Self-dispersible cyan pigment, produced by Cabot Specialty Chemicals, numerals in the table indicate pigment solid content amounts.
(*2): Self-dispersible magenta pigment, produced by Cabot Specialty Chemicals, numerals in the table indicate pigment solid content amounts.
(*3): Self-dispersible yellow pigment, produced by Cabot Specialty Chemicals, numerals in the table indicate pigment solid content amounts.
(*4): Sodium polyoxyethylene (3 E.O.) alkyl (C = 12, 13) ether sulfate, produced by Lion Corporation, active ingredient amount = 28% by weight, numerals in the table indicate active ingredient amounts.

As shown in Table 1, in the case of the water-based inks of Examples 1 to 21, all of the evaluation results were satisfactory in relation to the ink observation evaluation, print quality evaluation and discharge stability evaluation. Further, Example 1-3, 5-13 and 15-21 in each of which the blending amount of TPG was not more than 20% by weight was particularly excellent in the discharge stability, as compared with Examples 4 and 14 in which the blending amount of TPG exceeded 20% by weight. Furthermore, Example 1-4, 6-14 and 16-21 in each of which the blending amount of TPG was not less than 12% by weight was particularly excellent in the print quality, as compared with Examples 5 and 15 in which the blending amount of TPG was less than 12% by weight. Moreover, in the case of the water-based inks of Examples 1-3, 6-13 and 16-21 in each of which the blending amount of TPG was in the range of 12% by weight to 20% by weight, all of the evaluation results were highly satisfactory in relation to the ink observation evaluation, print quality evaluation and discharge stability evaluation.

On the other hand, as shown in Table 2, the result was unsatisfactory in relation to the evaluation of the print quality in the case of the water-based inks of Comparative Examples 1, 11 and 18 which did not use the 1,2-diol having the number of 8 to 10 carbon atoms, in the case of the water-based inks of Comparative Examples 4, 6, 7 and 15 which used DPG, TEG or polyethylene glycol 200 rather than using TPG, and in the case of the water-based inks of Comparative Examples 10 and 17 which used 1,2-butanediol rather than using the 1,2-diol having the number of 8 to 10 carbon atoms. Further, the result was unsatisfactory in relation to the evaluation of the discharge stability in the case of the water-based inks of Comparative Examples 2, 8, 12, 14 and 19 in each of which the blending amount of TPG was 32.0% by weight. Furthermore, the result was unsatisfactory in relation to the evaluation of the ink observation in the case of the water-based inks of Comparative Examples 3 and 13 in which the weight ratio (X:Y) was 2:1, in the case of the water-based ink of Comparative Example 5 which used polypropylene glycol rather than using TPG, and in the case of the water-based inks of Comparative Examples 9 and 16 which used 1,2-tetradecanediol rather than using the 1,2-diol having the number of 8 to 10 carbon atoms.

As described above, the water-based ink of the present teaching is capable of suppressing the lowering in print quality due to the density non-uniformity. The usage of the water-based ink of the present teaching is not particularly limited, and is widely applicable to a variety of kinds of ink-jet recording.

What is claimed is:

1. A water-based ink for ink-jet recording comprising:
a pigment;
water;
tripropylene glycol contained not more than 28% by weight in the water-based ink; and
1,2-diol having a number of 8 to 10 carbon atoms;
wherein a weight ratio (X:Y) of the tripropylene glycol (X) to the 1,2-diol (Y) in the water-based ink is in a range of X:Y=50:1 to 2.4:1.

2. The water-based ink for ink-jet recording according to claim 1, wherein the tripropylene glycol is contained by 10% by weight to 28% by weight in the water-based ink.

3. The water-based ink for ink-jet recording according to claim 1, wherein the tripropylene glycol is contained by 12% by weight to 20% by weight in the water-based ink.

4. The water-based ink for ink-jet recording according to claim 1, wherein the 1,2-diol is straight-chain alkanediol.

5. The water-based ink for ink-jet recording according to claim 4, wherein the 1,2-diol is at least one selected from the group consisting of 1,2-octanediol and 1,2-decanediol.

6. The water-based ink for ink-jet recording according to claim 1, wherein the 1,2-diol is contained by 0.3% by weight to 5% by weight in the water-based ink.

7. The water-based ink for ink-jet recording according to claim 1, wherein the weight ratio (X:Y) of the tripropylene glycol (X) to the 1,2-diol (Y) in the water-based ink is in a range of X:Y=50:1 to 5:1.

8. The water-based ink for ink-jet recording according to claim 1, wherein the pigment is a chromatic color pigment.

9. The water-based ink for ink-jet recording according to claim 1, wherein the pigment is at least one selected from the group consisting of a yellow pigment, a magenta pigment and a cyan pigment.

10. A water-based ink for ink-jet recording comprising:
a chromatic color pigment;
water;
tripropylene glycol contained not more than 28% by weight in the water-based ink; and
1,2-diol which is contained by 0.3% by weight to 5% by weight in the water-based ink and which is at least one selected from the group consisting of 1,2-octanediol and 1,2-decanediol;
wherein a weight ratio (X:Y) of the tripropylene glycol (X) to the 1,2-diol (Y) in the water-based ink is in a range of X:Y=50:1 to 2.4:1.

11. An ink cartridge comprising the water-based ink for ink jetrecording as defined in claim 1.

12. An ink jetrecording apparatus comprising:
the water-based ink for ink-jet recording as defined in claim 1;
an ink accommodating section configured to accommodate the water-based ink; and
an ink discharge mechanism configured to discharge the ink accommodated in the ink accommodating section.
